(19) United States
(12) Patent Application Publication
(10) Pub. No.: US 2020/0356106 A1
(43) Pub. Date: Nov. 12, 2020

(54) Bulk Handling With Autonomous Vehicles

(71) Applicant: Mo-Sys Engineering Limited, London (GB)

(72) Inventors: Michael Paul Alexander GEISSLER, London (GB); Martin Peter PARSLEY, London (GB)

(21) Appl. No.: 16/962,770

(22) PCT Filed: Jan. 17, 2019
(86) PCT No.: PCT/GB2019/050126

§ 371 Date: Jul. 16, 2020

(30) Foreign Application Priority Data
Jan. 17, 2018 (GB) 1800751.8

(51) Int. Cl. G05D 1/02

(52) U.S. Cl. CPC G05D 1/0234; G05D 1/0253; B60P 3/22; G05D 2201/0216; G05D 1/0225

(57) ABSTRACT

A method for automatically moving a vessel along a desired path, the method comprising: providing an irregular pattern of indicia remote from the vessel; imaging the indicia by an imaging device carried by the vessel and thereby estimating the location and orientation of the vessel with respect to the indicia; driving the vessel in dependence on the estimated location and orientation in order to cause the vessel to move along the path.

This invention relates to the bulk handling of fluids and particulate materials.

In chemical production facilities fluids and particulate materials may be moved in vessels. The vessels may be docked with couplings on other vessels or on processing equipment to load and unload the vessels. Typically, in order to dock a vessel with a coupling it must approach the coupling in the correct direction (e.g. in a direction of motion that is aligned with a central axis of the coupling) and with the vessel correctly orientated (e.g. such that a coupling on the vessel is facing the coupling with which it is to mate). This can require relatively precise control over the position, motion and orientation of the vessel.

The vessels may be moved automatically or under manual control. When the vessels are moved automatically, a mechanism is required to permit the control system to know the position and orientation of the vessel.

One way to track vessels is by using radio positioning. Radio positioning has a number of weaknesses. For example, it may be subject to interference, and it cannot typically determine the orientation of a vessel unless the vessel is provided with multiple radio transmitters or receivers.

It would be desirable to be able to have an improved way of determining and controlling the positions of vessels.

According to one aspect there is provided a method for automatically moving a vessel along a desired path, the method comprising: providing an irregular pattern of indicia remote from the vessel; imaging the indicia by an imaging device carried by the vessel and thereby estimating the location and orientation of the vessel with respect to the indicia; driving the vessel in dependence on the estimated location and orientation in order to cause the vessel to move along the path.

According to a second aspect there is provided apparatus for automatically moving a vessel along a desired path, the apparatus comprising: a drive mechanism for driving the vessel to move; an irregular pattern of indicia remote from the vessel; an imaging device carried by the vessel; and one or more processors configured to: (i) receive images sensed by the imaging device and thereby estimate the location and orientation of the vessel with respect to the indicia and (ii) cause the drive mechanism to drive the vessel in dependence on the estimated location and orientation so as to cause the vessel to move along the path.

The vessel may comprise a first coupling capable of mating with a second coupling by engaging with the second coupling along a mating direction and with the first and second couplings mutually orientated in a mating configuration. The vessel may be moved in dependence on the estimated location so as to cause the first coupling to approach the second coupling along the mating direction and the vessel may be orientated in dependence on the estimated orientation so as to cause the first coupling to mate with the second coupling. The vessel may be orientated so as to align the couplings so that they are mutually orientated in the mating configuration. Each coupling may be configured so as to define a mating axis which is such that when another coupling is introduced to the first coupling along that axis the two may mate. The vessel may be orientated so that the mating axes of the first and second coupling lie on a common axis.

The indicia may be located above the vessel, e.g. on a downward-facing surface such as a ceiling. This can improve the ease of imaging the indicia.

The step of estimating the location of the vessel may comprise: receiving by means of the imaging device carried by the vessel a series of images of the environment captured by that imaging device; detecting in the images captured by that imaging device the representation of each of a plurality of indicia located in the environment; and forming the said estimate of the position of the vessel by comparing the locations of representations of the indicia in images captured at different times.

The step of estimating the orientation of the vessel may comprise: receiving by means of the imaging device carried by the vessel a series of images of the environment captured by that imaging device; and detecting in the images captured by that imaging device the representation of each of a plurality of indicia

The representation of each of the indicia may be identified in the image as a relatively high brightness region of the image.

The indicia may be retroreflective. They may be of a retroreflective material. They may reflect incident light from at least one direction over a range of at least 90 degrees or at least 120 degrees.

The indicia may be identical or substantially identical.

The indicia may be located on a downwards-facing surface of the environment.

There may be a drive mechanism for driving the vessel to move. The drive mechanism may comprise one or more electric motors, linear actuators or other motion devices that can be controlled so as to induce motion of the vessel.

The present invention will now be described by way of example with reference to the accompanying drawings.

In the drawings:

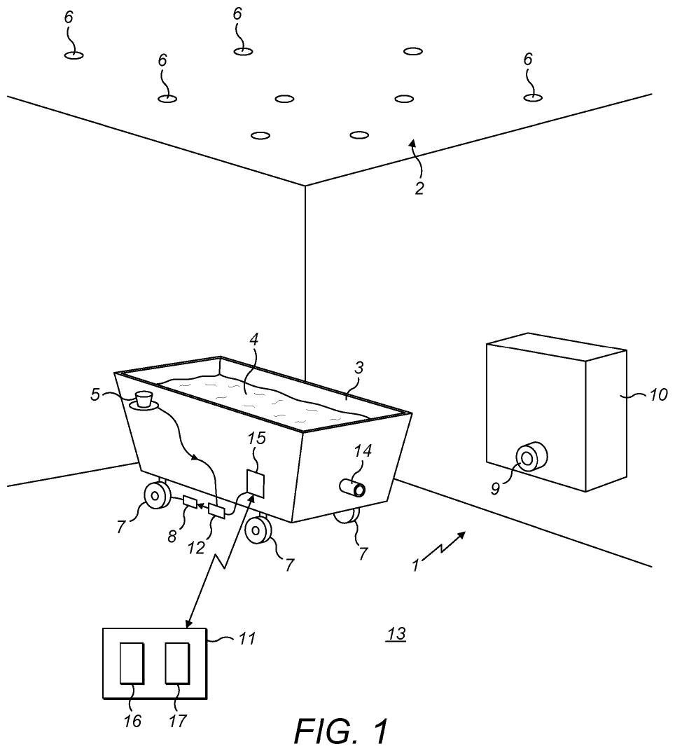

FIG. 1 shows a chemical production environment.

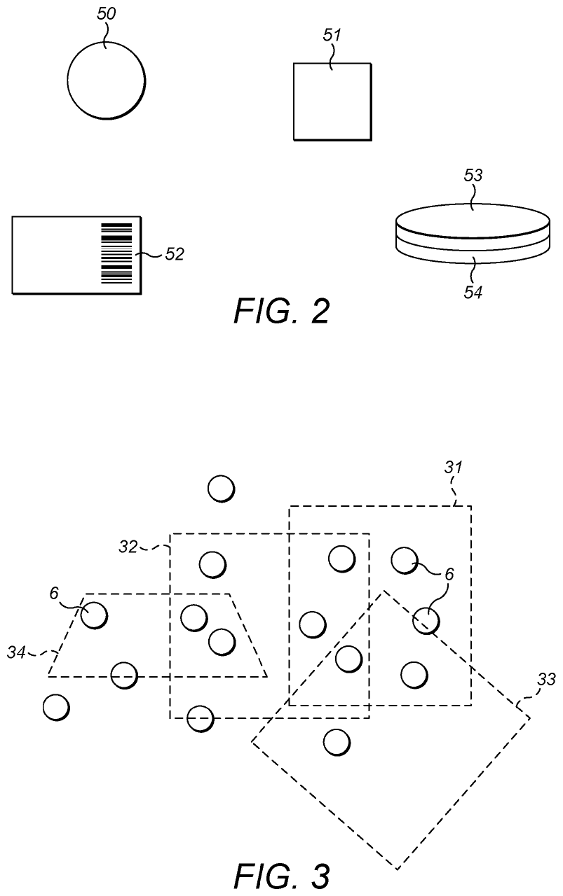

FIG. 2 shows examples of indicia.

FIG. 3 shows a pattern of indicia in an environment and frames captured by an imaging device such as a camera.

The system of FIG. 1 comprises a workplace 1. A ceiling 2 extends over the workplace.

In the workplace a mobile vessel 3 contains liquid 4. The vessel could be open or closed. It could contain liquid, gas or a particulate material, or it could be empty and available to be charged with such media. The vessel may, for example be an intermediate bulk container (IBC). The vessel can be moved around the workplace. In this example the vessel is supported on wheels 7, but it could run on skids, tracks, air bearings or any suitable supports. It could be carried by a hoist. In this example the wheels can be driven by motors 8 under the control of a controller 12. The controller can cause the vessel to move in any desired direction across a floor 13 of the workplace. This may be done by steering the wheels 7 or driving them differentially. The controller can also cause wheels to be driven so as to rotate the vessel about a vertical axis.

The vessel has a coupling 14. The coupling is presented externally of the vessel and communicates with the interior of the vessel. The coupling may extend proud of the exterior of the vessel. The vessel may be drained or filled by the passage of material through the coupling. The coupling may, for example, be a dry break coupling as available from Fluid Control Service AS of Norway.

A secondary piece of equipment 10 has a second coupling 9. The second coupling is configured to mate with the first coupling 14 of the vessel. Either of the first and second couplings may be male. The other of the couplings may be of the opposite gender. The secondary equipment may be of any suitable type. For example, it may be a tank, an item of fluid processing machinery or a hose. The location of the second coupling 9 may be fixed or mobile.

In order for the couplings 14 and 9 to mate, they must be brought together at a common location. The couplings may also be such that in order for the couplings to mate they must approach each other in a particular direction or range of directions.

That direction may be parallel to a central axis of one or both couplings, or within a predetermined angular range of that direction. When the equipment 10 is fixed in location, and the coupling 9 is fixed in location, in order for the vessel's coupling 14 to mate with the equipment's coupling it may be necessary for the vessel to approach the equipment in a particular direction or within a predetermined angular range of that direction.

Motion of the vessel may be controlled by the controller 12. Alternatively, the controller 12 may communicate via a transceiver 15 carried by the vessel with a remote control station 11. The control station may command the controller 12 to move the vessel along a desired path and/or to orientate the vessel in a desired orientation.

The vessel has a positioning unit 5. The positioning unit may comprise a camera directed away from the vessel. The positioning unit 5 is preferably attached to the vessel in a predetermined location and orientation, so that the position and orientation of the vessel with respect to the positioning unit 5 is known. Alternatively, one or both of the position and orientation of the vessel with respect to the positioning unit can be learned as the vessel is moved: for example when it is in a reference position and/or orientation.

The positioning units 5 feeds data to control unit 12, and optionally to remote control station 11.

The positioning system 5 may operate as described in EP 2 962 284.

Indicia 6 are applied to objects in the workplace 1. In this example the indicia are applied to the ceiling 2 of the workplace. The indicia are preferably of an appearance that is readily distinguishable from the environment. For example, they may be of very high reflectivity (e.g. of retroreflective material) or of very low reflectivity (e.g. having a matt black surface coating), or they may be of a defined colour, for example a specific green. When the indicia are of high reflectivity, preferably each one is of a material that reflects preferentially in a direction orthogonal to its major plane, as may be the case with dedicated retroreflective materials. The indicia are preferably flat: for example, they may be in the form of laminar stickers applied to one or more surfaces. This can make them easy to apply in the environment. The indicia preferably bear no surface markings (e.g. numbers or bar codes) by which each one can be distinguished from the others. This can make the task of applying the indicia in the environment easier. The indicia may all have the same outline (e.g. round or square) or they may have different outlines. The indicia are positioned in an irregular pattern. The pattern is preferably non-repeating. This may be achieved by randomly positioning the indicia in the environment. Positioning the indicia in an irregular pattern can make the task of applying the indicia easier and also facilitates locating objects in the environment, as will be described below. The indicia may all be of the same size, which may help their range to be determined as will be described further below, or of different sizes. In summary, in a preferred arrangement the indicia are provided by identical retroreflective stickers which are applied to the environment in an irregular or random pattern.

FIG. 2 shows examples of indicia. The indicia could be round (see 50), square (see 51) or of other shapes. The indicia could bear markings such as barcode 52 which allow any of the indicia to be distinguished uniquely from the others, or they may bear no such markings. Conveniently the indicia take the form of stickers having an upper surface 53 of a predetermined colour and/or reflectivity and a lower adhesive surface 54 by means of which they may be adhered to the environment.

The indicia may be located on upwards-facing, downwards-facing or sideways-facing surfaces of the environment. It is preferred that at least some of the indicia are located on downwards-facing surfaces, e.g. ceiling 2. Such a downward-facing surface may be above the place where the vessel 3 is located. Visibility of indicia located above a detector 5 is typically better than of indicia located sideways of or below the detector because it is in general less likely to be obstructed by other objects or people.

As discussed above, the vessel 3 carries a positioning device 5. The positioning device comprises an imaging device such as a camera. The camera of the vessel is configured to capture images in a direction generally away from the vessel. The camera is preferably directed upwards. The camera is preferably detected so as to be able to image at least some of the indicia 6 when the vessel is in its intended orientation in the workplace. Images, e.g. video frames, gathered by the camera are processed to estimate the location of the respective positioning unit. From that location the location of the object carrying the respective positioning unit can be inferred.

The camera of a positioning device and the indicia 6 enable the location of the positioning device to be estimated in the workplace. The manner in which this is achieved will now be described with reference to FIG. 3.

The camera of a positioning unit 5 captures a series of frames. The direction in which the camera of the positioning unit is pointing when it captures a frame depends on how the object carrying the respective positioning unit is positioned at that time. FIG. 3 shows indicia 6 in an irregular pattern, and a set of outlines 31, 32, 33, 34 indicating the boundaries of frames captured by the camera of a positioning unit. The positioning unit comprises a processor and a memory. The memory stores in non-transitory form a set of instructions executable by the processor to perform its functions. The processor receives the successive frames captured by the camera of the positioning unit. The processor analyses each frame to detect the locations of the indicia 6 as represented in the frame. The indicia may be detected through their characteristic brightness, shape, colour or a combination of those factors. For example, in the case of retroreflective indicia the indicia may be indicated by particularly bright pixel groups in the image.

By comparing the position and layout of the indicia as detected in successive frames the processor can (a) build up a map of the pattern or constellation formed by the indicia and (b) infer the motion of the positioning unit between frames. For illustration, suppose at a first time the camera of a positioning unit captures the image indicated at 31. The processor identifies the indicia 6 in that image. The indicia can be considered to lie on vectors extending from the camera and intersecting the locations of the indicia as represented in image 31. At this stage the ranges of the indicia from the camera are not known. At a second time the camera captures the image indicated at 32. Some indicia are common to images 31 and 32. Because the indicia are positioned irregularly it can be assumed that the relative positions of the indicia found in each frame are unique in the field of indicia. By comparing the positions of the images of indicia in successive frames the processor can build up a record of where in a three-dimensional space the actual indicia are. For example, because three indicia 6 appear in a common spatial relationship in frames 31 and 32 it can be inferred that the camera has undergone translation between those images without rotation or tilting. Comparison of the positions of the indicia in frame 33 with those in the other frames 31, 32 whose fields of view overlap frame 33 permit the processor to infer that the positioning unit was rotated about its primary axis before frame 33 was captured. Comparison of the positions of the indicia in frame 34 with those in the other frames (e.g. 32) whose fields of view overlap frame 34 permit the processor to infer that the positioning unit was tilted before frame 33 was captured. Similarly, motion of the positioning unit towards or away from the field of indicia can be detected through scaling of the detected positions of the indicia between successive frames.

The accuracy of this positioning method can be improved if the camera of the positioning unit has a relatively wide field of view and/or if the density of the field of indicia is such that numerous indicia can be expected to be captured in each frame. That makes it less likely that there will be positional ambiguity due to multiple indicia accidentally having a similar positional relationship and therefore being confused as between images. That also reduces the influence of other objects that might appear similar to indicia (e.g. lights) and that might move. In solving for the position of the camera, the processor searches for the best fit to the collected data, but that fit might not be perfect: for example it might not fit to a mobile light that has been mistakenly identified as one of the indicia.

The position of indicia in an image indicates the direction of those indicia with respect to the camera of the positioning unit but not necessarily their distance from the camera. It may be possible for the processor of the positioning unit to infer the distance to indicia from the size with which they appear in the image. Alternatively, or in addition, the distance to indicia may be inferred from the changes in the imaged positions of indicia as between frames. The processor solves a multi-variable problem in which the relative directions from the camera of the positioning unit to the indicia in successive frames are known. The processor determines a map of the indicia that provides the best fit to the information collected in successive frames as to the directions of indicia from the camera. Having formed the map, it estimates the position of the camera with reference to that map by identifying a position and orientation from which a view of the mapped indicia would be expected to best match the indicia as identified in the latest image from the camera. This problem can be simplified if it is known with greater confidence that the same one of the indicia as is represented at a location in a first frame is also represented at a location in a second frame. This relationship can be achieved by one or both of: (i) the rate at which the frames are captured being sufficiently high that one or more indicia will typically appear in successive frames, and can therefore be tracked by the processor; and (ii) the processor searching for common spatial patterns among the indicia as imaged, which indicate that the same set of indicia have been imaged in different frames.

It would be possible for the processor to be pre-programmed with the locations of the indicia, but it has been found that with a constellation of indicia of suitable density this is not necessary because the processor can learn their locations satisfactorily. It may, however, assist in permitting a translational and/or rotational offset between a position determined by the positioning unit and a reference location/orientation in the studio to be determined. Alternatively, that can be determined by placing the positioning unit at a known location and/or orientation in the studio, and then tracking its subsequent motions.

It would be possible for the indicia to be provided with distinctive markers, to help the processor distinguish the images of different indicia from each other. Those could for example be numbers or bar codes, or the shape or colour of different indicia may differ so that they can be differentiated.

Using the process described above, the processor detects and tracks motion of the camera.

The positioning system 5 provides outputs indicating the locations of the vessel 3 over time. These are provided to controller 12 and/or controller 11. Each controller comprises a processor (e.g. 16) and a memory (e.g. 17). The memory stores in a non-transitory way code that is executable by the processor to cause the controller to perform the functions described of it herein.

Whichever controller is in command of the motion of the vessel receives instructions defining the intended movement path of the vessel, including its orientation. These can be stored in the appropriate memory. For example, the data may indicate that he vessel is to be driven across the floor 13 to cause connector 14 to mate with connector 9. As discussed above, this may require that the vessel adopts specific orientation as it approaches connector 9. The data may also define the locations of the coupling 14 on the vessel 3 with respect to a reference location and orientation such as the location and orientation at and in which the location detector 5 is positioned.

When work is taking place, the system operates as follows.

The location device 5 is continually or intermittently tracking the location in the workplace 1 of vessel. It does this by reference to the indicia 6, as described above. The locations of the objects are passed to the active controller 11/12.

The controller can control the motion of the vessel in dependence on feedback from the location sensor 5 so as to cause the vessel to traverse the desired path and in the desired orientation. Offset between the desired location and the actual location of the vessel can be detected, and the motors driving the vessel can be operated so as to reduce that offset and cause the vessel to move along a desired path. Because the location sensor can detect its position and its orientation with respect to the field of indicia 6, the location and orientation may be controlled in response to a single location device on the vessel.

Thus, the system described above may provide a number of advantages over other systems. First, it can allow the orientation of the vessel to be determined without the use of multiple transmitters/receivers on the respective object. Second, the equipment 10 may also be movable and its position and orientation may be determined in a similar way to those of vessel 3. Because the locations of the vessel 3 and the equipment 10 are determined optically with respect to a common constellation of indicia 6 the relative locations of the objects might be reliably determined, and without risk of radio interference.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for automatically moving a vessel along a desired path, the method comprising:
providing an irregular pattern of indicia remote from the vessel;
imaging the indicia by an imaging device carried by the vessel;
building a map of the pattern formed by the indicia by comparing the position and layout of the indicia as detected in successive frames imaged by the imaging device and thereby estimating the location and orientation of the vessel with respect to the indicia;
driving the vessel in dependence on the estimated location and orientation in order to cause the vessel to move along the path.

2. A method as claimed in claim 1, wherein the vessel comprises a first coupling capable of mating with a second coupling by engaging with the second coupling along a mating direction and with the first and second couplings mutually orientated in a mating configuration, and the method comprises moving the vessel in dependence on the estimated location so as to cause the first coupling to approach the second coupling along the mating direction and orientating the vessel in dependence on the estimated orientation so as to cause the first coupling to mate with the second coupling.

3. A method as claimed in claim 1, wherein the indicia are located above the vessel.

4. A method as claimed in claim 1, wherein the step of estimating the location of the vessel comprises:
receiving by means of the imaging device carried by the vessel a series of images of the environment captured by that imaging device;
detecting in the images captured by that imaging device the representation of each of a plurality of indicia located in the environment; and
forming the said estimate of the position of the vessel by comparing the locations of representations of the indicia in images captured at different times.

5. A method as claimed in claim 1, wherein the step of estimating the orientation of the vessel comprises:
receiving by means of the imaging device carried by the vessel a series of images of the environment captured by that imaging device;
detecting in the images captured by that imaging device the representation of each of a plurality of indicia located in the environment; and
forming the said estimate of the orientation of the vessel by comparing the locations of representations of the indicia in images captured at different times.

6. A method as claimed in claim 5, comprising detecting the representation of each of the indicia in the image as a relatively high brightness region of the image.

7. A method as claimed in claim 1, wherein the indicia are retroreflective.

8. A method as claimed in claim 1, wherein the indicia are substantially identical.

9. A method as claimed in claim 1, wherein the indicia are located on a downwards-facing surface of the environment.

10. Apparatus for automatically moving a vessel along a desired path, the apparatus comprising:
a drive mechanism for driving the vessel to move;
an irregular pattern of indicia remote from the vessel;
an imaging device carried by the vessel;
one or more processors configured to: (i) receive images sensed by the imaging device and build a map of the pattern formed by the indicia by comparing the position and layout of the indicia as detected in successive frames of the received images and thereby estimate the location and orientation of the vessel with respect to the indicia and (ii) cause the drive mechanism to drive the vessel in dependence on the estimated location and orientation so as to cause the vessel to move along the path.

11. A method as claimed in claim 4, comprising detecting the representation of each of the indicia in the image as a relatively high brightness region of the image.
